(19) United States
(12) Patent Application Publication
(10) Pub. No.: US 2021/0224703 A1
(43) Pub. Date: Jul. 22, 2021

(54) GENERATION METHOD, INFORMATION PROCESSING APPARATUS, AND NON-TRANSITORY COMPUTER-READABLE STORAGE MEDIUM FOR STORING GENERATION PROGRAM

(71) Applicant: FUJITSU LIMITED, Kawasaki-shi (JP)

(72) Inventors: Tadanobu Tsunoda, Kawasaki (JP); Kazuya UNO, Yokohama (JP); Dai YAMAMOTO, Kawasaki (JP)

(73) Assignee: FUJITSU LIMITED, Kawasaki-shi (JP)

(21) Appl. No.: 17/129,537

(22) Filed: Dec. 21, 2020

(30) Foreign Application Priority Data
Jan. 16, 2020 (JP) 2020-005088

(51) Int. Cl. G06Q 10/06

(52) U.S. Cl. CPC G06Q 10/0635

(57) ABSTRACT

A generation method implemented by a computer, the method includes: calculating a degree of similarity between a business entity being evaluated and a counterparty business entity that has a business relationship with the business entity being evaluated; and generating information on a degree of trust in the business entity being evaluated, based on the calculated degree of similarity.

### CROSS-REFERENCE TO RELATED APPLICATION

This application is based upon and claims the benefit of priority of the prior Japanese Patent Application No. 2020-5088, filed on Jan. 16, 2020, the entire contents of which are incorporated herein by reference.

### FIELD

The embodiment discussed herein is related to a generation method, an information processing apparatus, and a non-transitory computer-readable storage medium storing a generation program.

### BACKGROUND

With the progress of information and communications technology (ICT), it is expected that transactions between business entities, which have been hitherto performed as face-to-face ones, are performed as non-face-to-face ones over the Internet.

In non-face-to-face transactions, a business entity is unable to directly recognize the counterparty, thus causing a problem: how the business entity can trust the counterparty. Information from the website of the counterparty on the Internet is not enough for establishing a trust relationship between the business entities.

If the counterparty has a business relationship with another business entity, analysis of the relationship allows the business entity to grasp the degree of trust in the counterparty viewed from the other business entity. Conceivably, the business entity may trust the counterparty by replacing the degree of trust in the counterparty viewed from the other business entity with that of the business entity.

Since information on business entities such as business relationships is stored in various applications and services in a distributed manner, it is not easy to grasp the information at once. Accordingly, in order to make it possible to easily grasp the degree of trust in a business entity from information on business relationships between business entities, these pieces of information on the business entities are expectedly integrated and provided in an easy-to-view form for a user.

For example, in Japanese Laid-open Patent Publication No. 2015-026388, a mechanism is provided in which attribute information such as a name and a location of each business entity and business relationship information including customer business entities, supplier business entities, and transaction-target items of the business entity are associated with unique business entity information, and links between the business entities are displayed as business entity map information having a graph structure.

In International Publication Pamphlet No. WO 2016/021522, transaction information between business entities and links between business entities obtained through a keyword search on websites of business entities or the like are converted into a directed graph, and the degrees of importance as suppliers of a procurement article are determined based on the number of counterparty business entities and the number of transaction documents.

In Japanese Laid-open Patent Publication No. 2019-057068, a complementary relationship between organizations is analyzed based on an issue and technical information of the organizations such as individual business entities collected from public technical documents, and cooperation between the organizations is supported.

Examples of the related art include Japanese Laid-open Patent Publication No. 2015-026388, International Publication Pamphlet No. WO 2016/021522, and Japanese Laid-open Patent Publication No. 2019-057068.

### SUMMARY

According to an aspect of the embodiments, a generation method implemented by a computer, the method includes: calculating a degree of similarity between a business entity being evaluated and a counterparty business entity that has a business relationship with the business entity being evaluated; and generating information on a degree of trust in the business entity being evaluated, based on the calculated degree of similarity.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating an example of a hardware configuration of an information processing apparatus according to an example of an embodiment;

FIG. 2 is a block diagram schematically illustrating an example of a functional configuration of the information processing apparatus illustrated in FIG. 1;

FIG. 3 describes a process of generating link information performed in the information processing apparatus illustrated in FIG. 1;

FIG. 4 illustrates a tree structure based on the international patent classification (IPC);

FIG. 5 describes a process of generating a competency tree performed in the information processing apparatus illustrated in FIG. 1;

FIG. 6 describes a process of calculating a degree of similarity performed in the information processing apparatus illustrated in FIG. 1;

FIG. 7 describes a process of calculating a degree of trust reliability performed in the information processing apparatus illustrated in FIG. 1;

FIG. 8 illustrates a first example of a display screen of the degree of trust reliability for a business entity being evaluated displayed by the information processing apparatus illustrated in FIG. 1;

FIG. 9 illustrates a second example of the display screen of the degree of trust reliability for the business entity being evaluated displayed by the information processing apparatus illustrated in FIG. 1;

FIG. 10 illustrates a display screen of a distribution graph of the degrees of trust reliabilities for a plurality of business entities displayed by the information processing apparatus illustrated in FIG. 1;

FIG. 11 describes details of the process of generating a competency tree performed in the information processing apparatus illustrated in FIG. 1;

FIG. 12 describes the details of the process of generating a competency tree performed in the information processing apparatus illustrated in FIG. 1;

FIG. 13 describes details of the process of calculating a degree of similarity performed in the information processing apparatus illustrated in FIG. 1;

FIG. 14 describes the details of the process of calculating a degree of similarity performed in the information processing apparatus illustrated in FIG. 1; and

FIG. 15 is a flowchart describing the process of calculating a degree of trust reliability performed in the information processing apparatus illustrated in FIG. 1.

### DESCRIPTION OF EMBODIMENT(S)

However, with the techniques described above, links between business entities and the number of links may be grasped but it is difficult to grasp whether the business entities are linked to each other really with trust in the capabilities of the counterparties. For example, links between business entities in a business entity map having a graph structure merely indicate the fact that there are transactions between the business entities and does not necessarily indicate that the business entities are linked to each other with trust in the capabilities of the counterparties. For example, links to other business entities linked to a business entity being evaluated and the number of links fail to directly indicate trust in the capabilities of the business entity being evaluated.

According to an aspect of the embodiments, provided is a solution to improve the accuracy of information on the degree of trust in a counterparty.

An embodiment will be described below with reference to the drawings. The following embodiment is merely illustrative and is in no way intended to exclude various modifications or technical applications that are not explicitly described in the embodiment. For example, the present embodiment may be carried out in various modified forms without departing from the gist thereof.

Each figure is not intended to include only the elements illustrated therein, and thus may include other functions and the like.

Since the same reference signs denote the same or similar components in the drawings, the description of such components is omitted.

### [A] Example of Embodiment

[A-1] Example of System Configuration

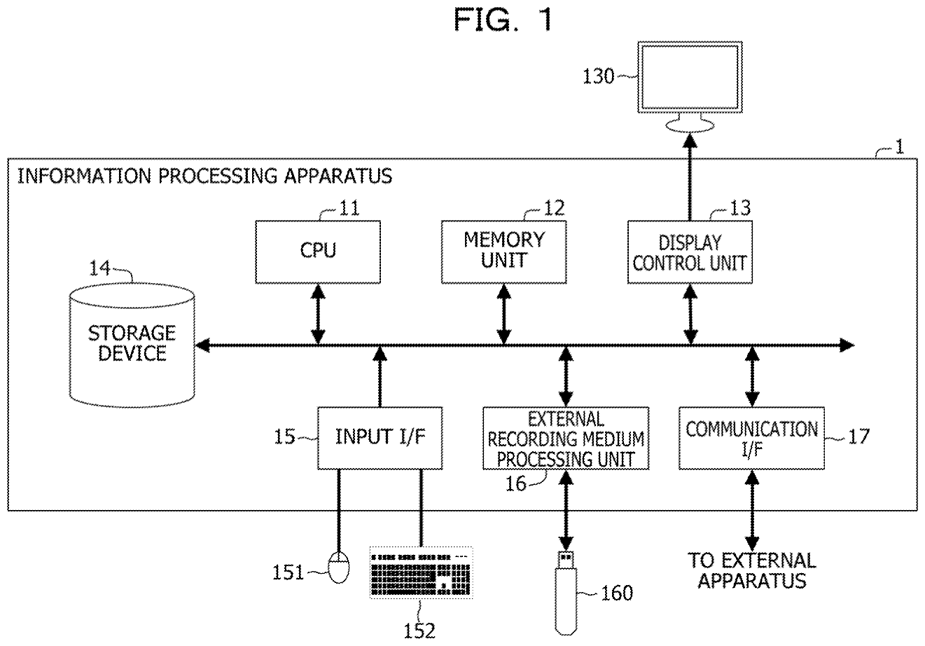

FIG. 1 is a block diagram schematically illustrating an example of a hardware configuration of an information processing apparatus 1 according to an example of an embodiment.

As illustrated in FIG. 1, the information processing apparatus 1 includes a central processing unit (CPU) 11, a memory unit 12, a display control unit 13, a storage device 14, an input interface (I/F) 15, an external recording medium processing unit 16, and a communication I/F 17.

The memory unit 12 is an example of a storage and includes, for example, a read-only memory (ROM), a random-access memory (RAM), and so on. Programs such as a basic input/output system (BIOS) may be written in the ROM of the memory unit 12. The software programs stored in the memory unit 12 may be appropriately loaded and executed by the CPU 11. The RAM of the memory unit 12 may be utilized as a memory for temporary storage or as a working memory.

The display control unit 13 is coupled to a display device 130 and controls the display device 130. The display device 130 is a liquid crystal display, an organic light-emitting diode (OLED) display, a cathode ray tube (CRT) display, an electronic paper display, or the like and displays various types of information for an operator or the like. The display device 130 may be combined with an input device. For example, the display device 130 may be a touch panel.

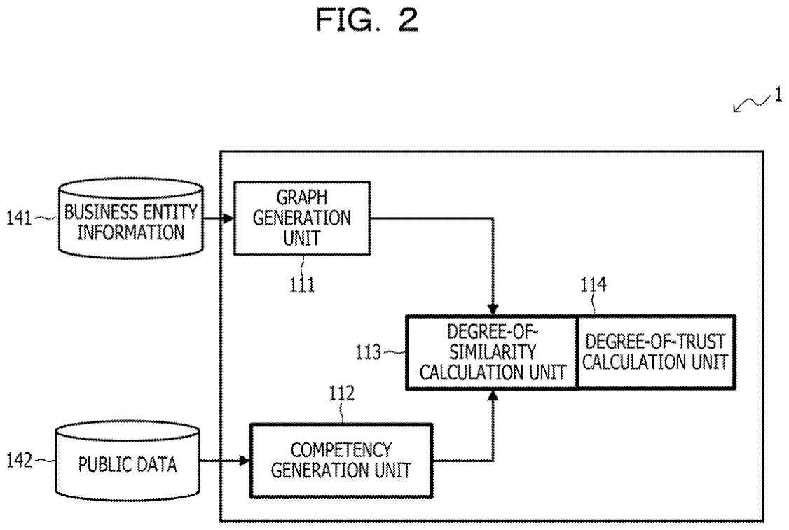

The storage device 14 is a storage device having high input/output performance. For example, a hard disk drive (HDD), a solid state drive (SSD), or a storage class memory (SCM) may be used as the storage device 14. The storage device 14 may store business entity information 141 and public data 142, which will be described later using FIG. 2.

The input I/F 15 may be coupled to input devices such as a mouse 151 and a keyboard 152 and may control the input devices such as the mouse 151 and the keyboard 152. Each of the mouse 151 and the keyboard 152 is an example of an input device. The operator performs various input operations using these input devices.

The external recording medium processing unit 16 is configured so that a recording medium 160 may be inserted thereto. The external recording medium processing unit 16 is configured to be able to read information recorded on the recording medium 160 in a state in which the recording medium 160 is inserted thereto. In the present example, the recording medium 160 is portable. For example, the recording medium 160 is a flexible disk, an optical disc, a magnetic disk, a magneto-optical disk, a semiconductor memory, or the like.

The communication I/F 17 is an interface that enables communication with an external apparatus.

The CPU 11 is a processing device that performs various kinds of control and various computations. The CPU 11 executes an operating system (OS) and the programs stored in the memory unit 12 to implement various functions.

The device that controls the operations of the entire information processing apparatus 1 is not limited to the CPU 11 and may be any one of an MPU, a DSP, an ASIC, a PLD, or an FPGA, for example. The device that controls the operations of the entire information processing apparatus 1 may be a combination of two or more kinds of a CPU, an MPU, a DSP, an ASIC, a PLD, or an FPGA. The MPU is an abbreviation of micro-processing unit. The DSP is an abbreviation of digital signal processor. The ASIC is an abbreviation of application-specific integrated circuit. The PLD is an abbreviation of programmable logic device. The FPGA is an abbreviation of field-programmable gate array.

FIG. 2 is a block diagram schematically illustrating an example of a functional configuration of the information processing apparatus 1 illustrated in FIG. 1.

As illustrated in FIG. 2, the information processing apparatus 1 functions as a graph generation unit 111, a competency generation unit 112, a degree-of-similarity calculation unit 113, and a degree-of-trust calculation unit 114.

The graph generation unit 111 generates a graph representing links between business entities, based on the business entity information 141. For example, the graph generation unit 111 integrates content included in the business entity information 141 and internally expresses links between business entities in a graph structure. The graph generation unit 111 summarizes, for each business entity, with which business entities the business entity has a business relationship, and extracts one or more other business entities having a business relationship with a business entity being evaluated by using, as a key, the name of the business entity being evaluated.

The business entity information 141 includes transaction situations between business entities. For example, the business entity information 141 may be deposit/withdrawal histories of bank accounts managed by financial institutions or account book information on blockchains related to transactions between the business entities. The business entity information 141 may be extracted from a website.

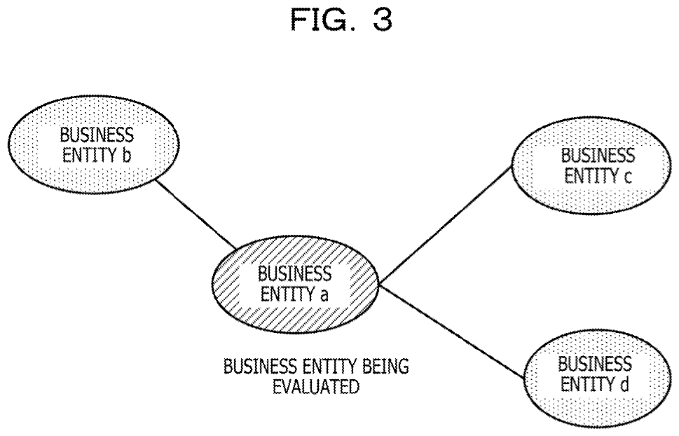

Details of a process performed by the graph generation unit 111 will be described later using FIG. 3 and so on.

The competency generation unit 112 generates a competency tree, based on the public data 142. For example, the competency generation unit 112 extracts competency information as structured data according to a predefined tree-like schema definition, by using the public data 142 on the competency of a business entity.

The public data 142 is information on capabilities (in other words, competency) of each business entity, and is information acquirable by anyone. The public data 142 may be, for example, content of patent applications, design registration applications, or trademark registration applications that have been filed by the business entity being evaluated and are on the web. For example, the public data 142 may be classification information such as the IRC, the FI term, and the F term of patent applications. The public data 142 may also be the design classification of design registration applications, or may be classification or the similar group code of products and services of trademark registration applications.

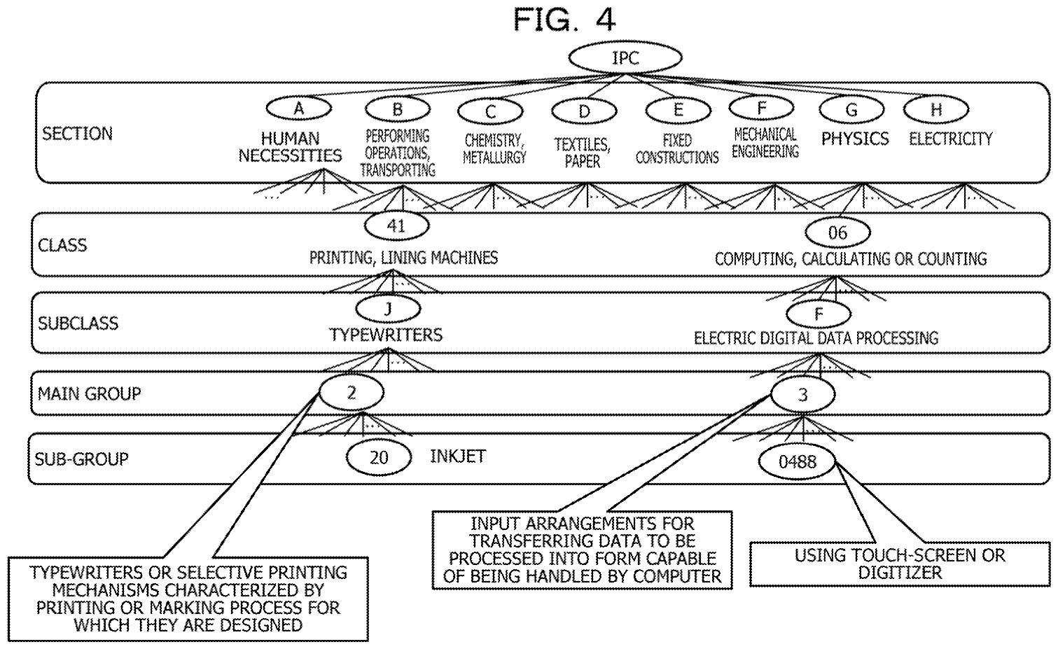

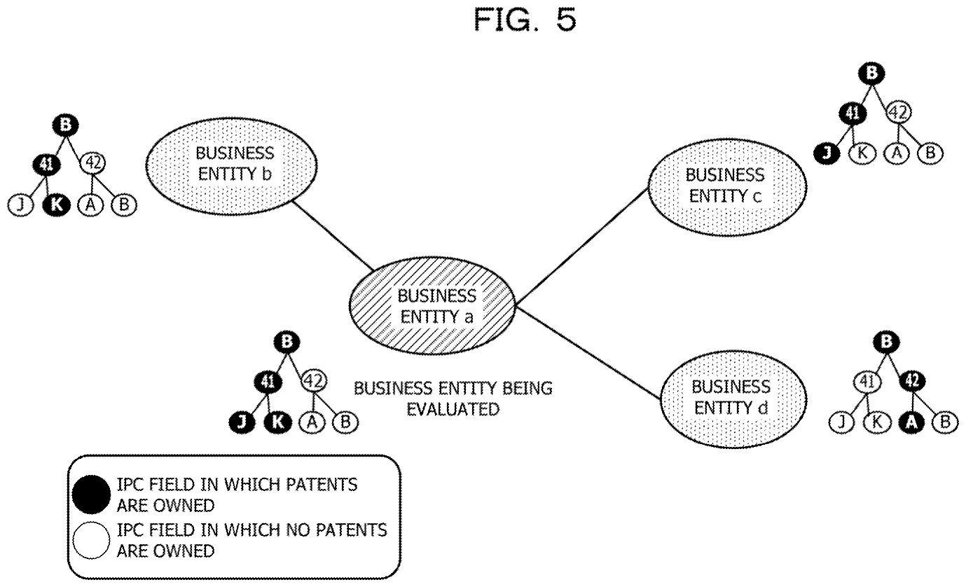

Details of a process performed by the competency generation unit 112 will be described later using FIGS. 4, 5, and so on.

The degree-of-similarity calculation unit 113 calculates a degree of similarity between competency trees of individual business entities. For example, the degree-of-similarity calculation unit 113 compares, for the business entity being evaluated and each business entity linked to the business entity being evaluated, pieces of competency information generated by the competency generation unit 112 and structured in a tree form, and calculates how similar their competencies are.

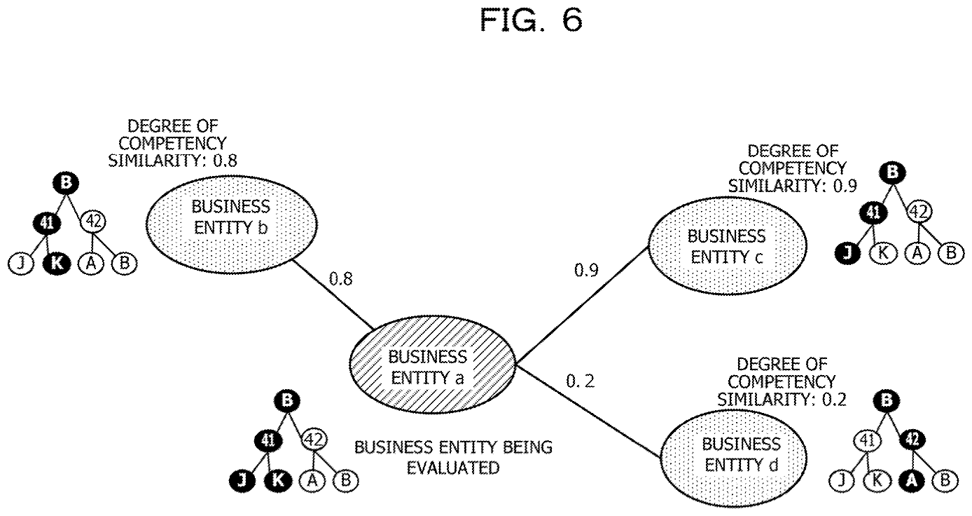

The details of a process performed by the degree-of-similarity calculation unit 113 will be described later using FIG. 6 and the like.

The degree-of-trust calculation unit 114 calculates a degree of trust reliability for the business entity being evaluated, based on the degrees of similarity between the business entity being evaluated and individual counterparties. For example, the degree-of-trust calculation unit 114 fuses the degrees of similarity between the business entity being evaluated and all the business entities linked to the business entity being evaluated, which are calculated by the degree-of-similarity calculation unit 113, to calculate the degree of trust reliability for the capabilities of the business entity being evaluated.

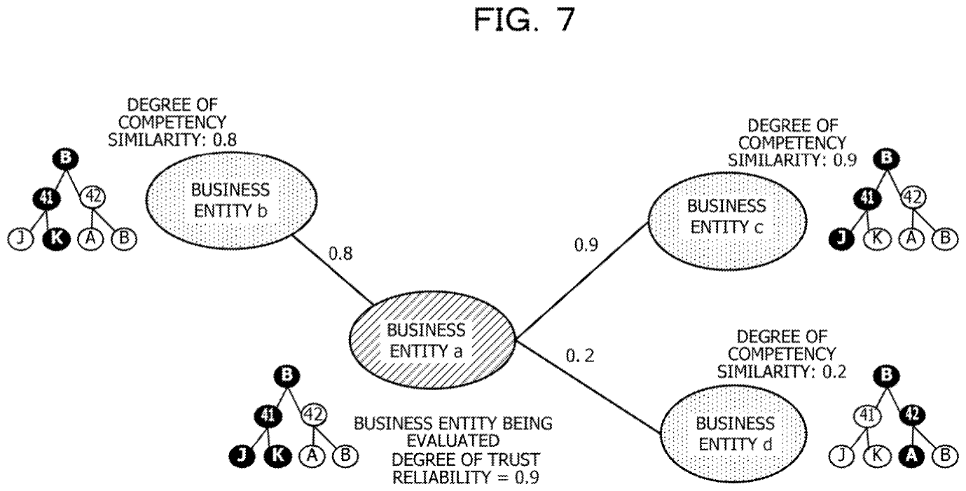

Details of a process performed by the degree-of-trust calculation unit 114 will be described later using FIG. 7 and so on.

FIG. 3 describes a process of generating link information performed in the information processing apparatus 1 illustrated in FIG. 1.

The graph generation unit 111 generates a graph in which a business entity having a link to, such as a business relationship with, a business entity a, which is a business entity being evaluated, is linked to the business entity a. In the example illustrated in FIG. 3, the graph generation unit 111 extracts business entities b to d as business entities having a link to the business entity a, and generates a graph in which the business entity a and the business entities b to d are linked to each other.

FIG. 4 illustrates a tree structure based on the IPC. FIG. 5 describes a process of generating a competency tree performed in the information processing apparatus 1 illustrated in FIG. 1.

For example, the competency generation unit 112 extracts, as competency information of a business entity, IPC information from the contents in acquired patent applications. For example, the competency generation unit 112 extracts the fields of technology which each business entity has, from the IPC classification of patents.

FIG. 5 illustrates that in which part of the IPC tree structure illustrated in FIG. 4 each of the business entity a, which is the business entity being evaluated, and the business entities b to d having a link to the business entity a owns patents.

In the example illustrated in FIG. 5, the business entity a owns patents indicated by “B41J” and “B41K”, and the business entity b owns patents indicated by “B41K” in the IPC classification illustrated in FIG. 4. The business entity c owns patents indicated by “B41J”, and the business entity d owns patents indicated by “B42A”.

FIG. 6 describes a process of calculating a degree of similarity performed in the information processing apparatus 1 illustrated in FIG. 1.

For example, the degree-of-similarity calculation unit 113 may calculate the degree of similarity from ratios of the numbers of nodes included in the trees of the competency information of the linked business entity to the numbers of respective nodes included in the trees of the competency information of the business entity being evaluated.

There may be a case where a business entity have obtained a plurality of patents or a case where, if a plurality of IPC classification categories are assigned to patents owned by a business entity, a percentage of each IPC field is determined as a calculation result from all the patents owned by the business entity. In such a case, the degree-of-similarity calculation unit 113 may calculate the degree of similarity, based on the ratio of the number of nodes occupied by the IPC field of the owned patents.

In the example illustrated in FIG. 6, the degrees of similarity of the business entities b, c, and d to the business entity a, which is the business entity being evaluated, are 0.8, 0.9, and 0.2, respectively. The degree of similarity may be represented by a value that is greater than or equal to 0 and less than or equal to 1, for example.

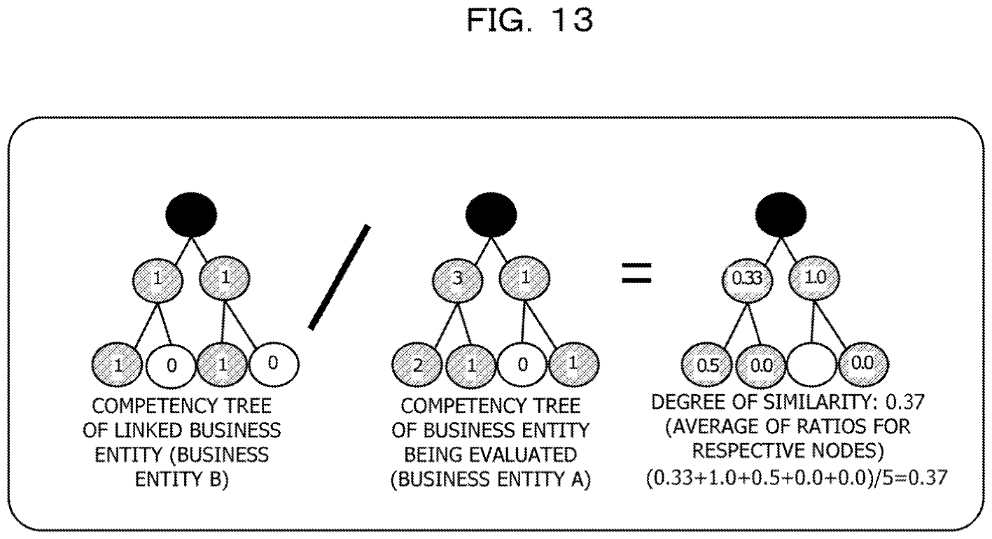

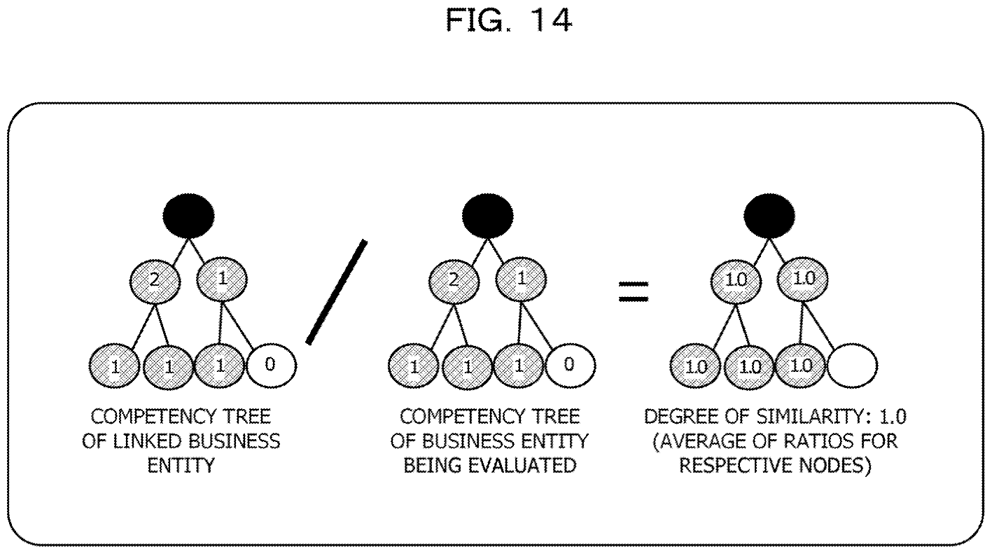

The details of the process of calculating the degree of similarity will be described later using FIGS. 13, 14, and so on.

FIG. 7 describes a process of calculating a degree of trust reliability performed in the information processing apparatus 1 illustrated in FIG. 1.

The degree-of-trust calculation unit 114 may calculate the degree of trust reliability by averaging the degrees of similarity for the respective links. The degree-of-trust calculation unit 114 may calculate the degree of trust reliability by determining a root mean square of the degrees of similarity for the respective links. The degree-of-trust calculation unit 114 may use, in calculation of the degree of trust reliability, a fusion operation of subjective logic (A. Josang, “Artificial Reasoning with Subjective Logic”, Proceedings of the Second Australian Workshop on Commonsense Reasoning, 1997), which enables quantitative handling of the subjective concept of trust.

In the example illustrated in FIG. 7, the degree of trust reliability for the business entity a, which is the business entity being evaluated, is 0.9. The degree of trust reliability may be represented by a value that is greater than or equal to 0 and less than or equal to 1, for example.

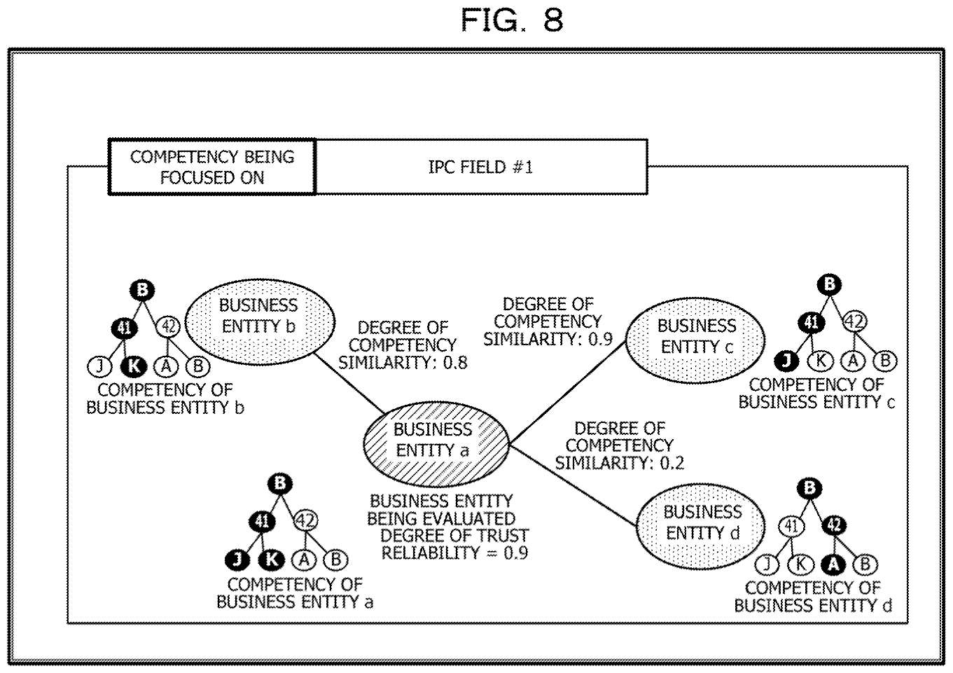

FIG. 8 illustrates a first example of a display screen of the degree of trust reliability for the business entity being evaluated displayed by the information processing apparatus 1 illustrated in FIG. 1.

In the display screen illustrated in FIG. 8, in addition to the map containing links between business entities, the competency trees of the respective business entities, the degrees of similarity in competency, and the degree of trust reliability for the business entity being evaluated are depicted in a graphical user interface (GUI).

In the example illustrated in FIG. 8, a value “IPC FIELD #1” is input as the competency being focused on. Thus, the degree of similarity to the business entity being evaluated is calculated only for business entities that own patents of the IPC field #1. The degree of trust reliability for the business entity being evaluated is then displayed.

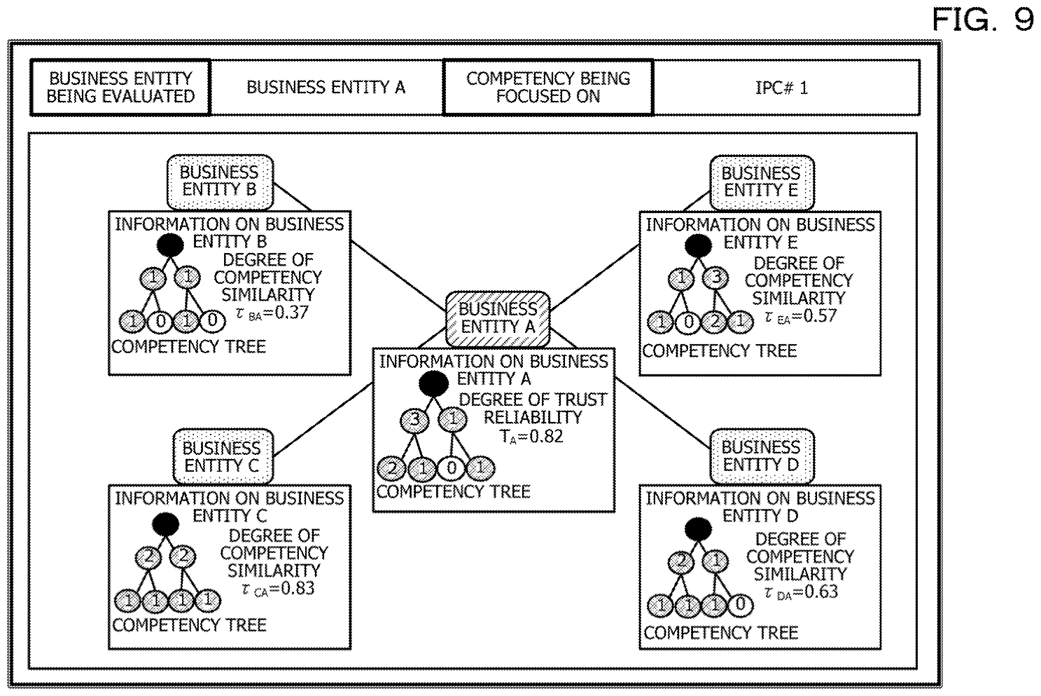

FIG. 9 illustrates a second example of the display screen of the degree of trust reliability for the business entity being evaluated displayed by the information processing apparatus 1 illustrated in FIG. 1.

In the example illustrated in FIG. 9, a business entity being evaluated is selectable in addition to the item described in the example illustrated in FIG. 8. In the illustrated example, “BUSINESS ENTITY A” is input as the business entity being evaluated, and “IPC FIELD #1” is input as the competency being focused oil. Consequently, the degree of trust reliability for the business entity A and the degrees of similarity, to the competency of the business entity A, of the competencies of the business entities B to E that have a link to the business entity A and own patents of the IPC field #1 are displayed.

The display screens illustrated in FIGS. 8 and 9 allow the degree of trust reliability to be checked in terms of the capabilities of the business entity being evaluated with respect to the competency being focused on. This may be useful to grasp the trust in the capabilities of a business entity that is a counterparty or a counterparty candidate and to perform transactions.

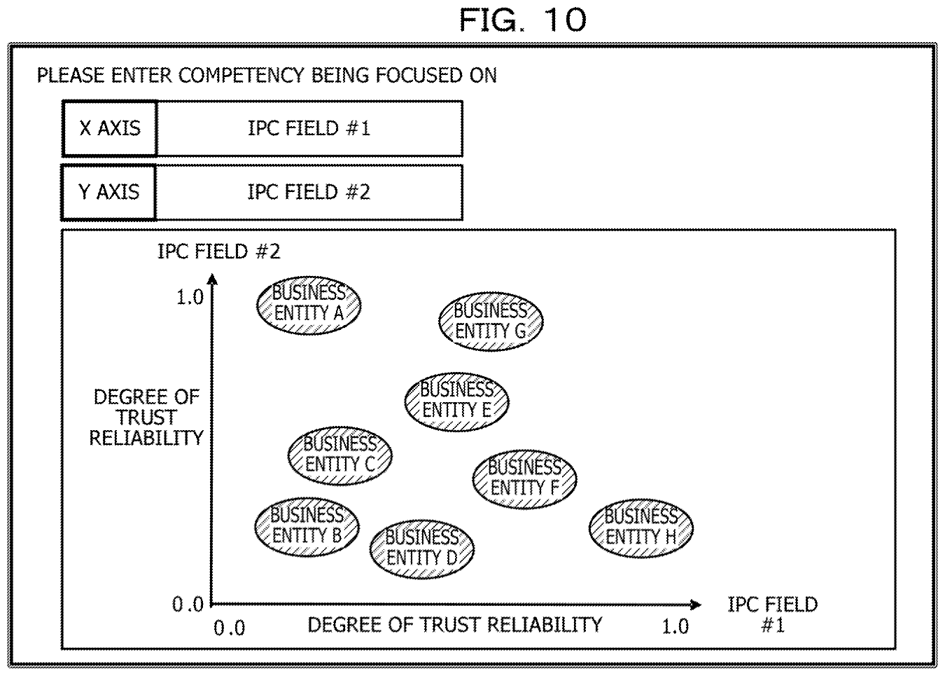

FIG. 10 illustrates a display screen of a distribution graph of the degrees of trust reliability for a plurality of business entities displayed by the information processing apparatus 1 illustrated in FIG. 1.

In the display screen illustrated in FIG. 10, results obtained by calculating, based on all the acquired business entity information 141, the degrees of trust reliability for individual business entities while the business entities are each regarded as the business entity being evaluated are mapped onto two-dimensional coordinates.

In the example illustrated in FIG. 10, as the competency being focused on, “IPC FIELD #1” is designated for the X axis coordinate, and “IPC FIELD #2” is designated for the Y axis coordinate. Consequently, the degrees of trust reliability for the business entities that own patents of the IPC field #1 and the IPC field #2 are mapped onto the two-dimensional coordinates.

The display screen illustrated in FIG. 10 may be useful in comparison and inspection performed when a counterparty is selected from among a plurality of counterparty candidates with emphasis on the capabilities of the counterparty business entity.

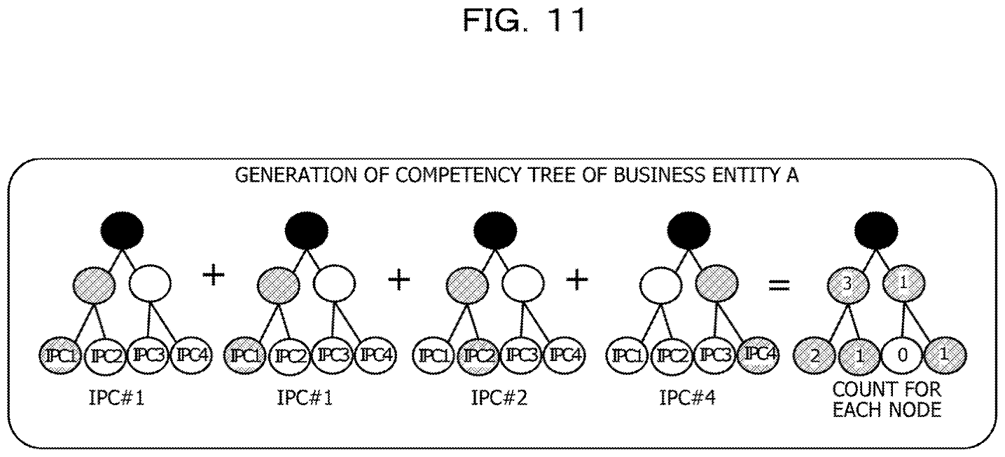

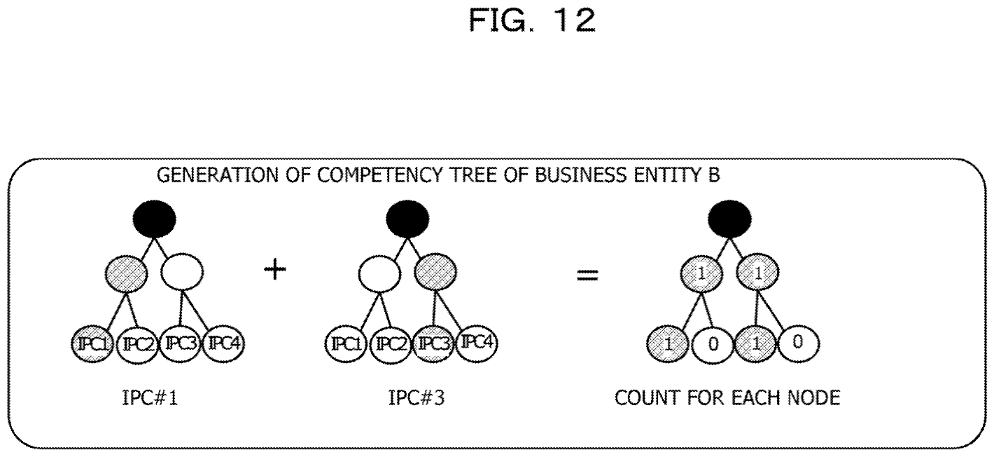

FIGS. 11 and 12 describe the details of the process of generating a competency tree performed in the information processing apparatus 1 illustrated in FIG. 1.

The competency generation unit 112 adds up the number of corresponding nodes existing in the structured data on the trees and holds, as a competency tree, the count excluding the root node of the tree.

In the example illustrated in FIG. 11, the business entity A owns two patents of the IPC #1, one patent of the IPC #2, and one patent of the IPC #4. In the example illustrated in FIG. 12, the business entity B owns one patent of the IPC #1 and one patent of the IPC #3.

FIGS. 13 and 14 describe the details of the process of calculating the degree of similarity performed in the information processing apparatus 1 illustrated in FIG. 1.

The degree-of-similarity calculation unit 113 may calculate ratios of the counts in every node of the competency tree of the linked business entity to the counts in every corresponding node of the competency tree of the business entity being evaluated. The degree-of-similarity calculation unit 113 may define, as the degree of similarity, an average of the ratios calculated for the individual nodes.

In the example illustrated in FIG. 13, the ratios are calculated by dividing the counts for each node in the competency tree of the linked business entity by the counts for each corresponding node in the competency tree of the business entity being evaluated. The calculated ratios are added up, and the sum of the calculated ratios is divided by the number of nodes having a count that is greater than or equal to 1 in the competency tree of the business entity being evaluated. For example, the calculation of the degree of similarity is as follows; (1/3+1/1+1/2+0/1+0/1)/5=(0.33+1.0+0.5+0.0+0.0)/5=0.37.

In the example illustrated in FIG. 14, all the counts of the nodes in the competency tree of the business entity being evaluated are equal to those in the competency tree of the linked business entity. Thus, the degree of similarity is 1.

A general formula of calculating the degree of similarity based on the average is determined as follows.

First, a number is assigned to each node of the tree constituting the competency schema, and a set of the numbers is denoted as I={1 2 3 4, . . . , n}. In the set I, the set of the numbers of the competency schema, sets of the numbers assigned to the nodes that are not empty in the competency trees of the respective business entities (for example, the business entity A and the business entity B) are denoted as I_{A} and I_{B} (I_{A} ⊂ I, I_{B} ⊂ I), respectively. The numbers of elements in the respective sets are denoted as nₐ and n_{b}. The counts of the node number i in the competency trees of the business entity A and the business entity B are respectively denoted as

Sᵢ^{A},Sᵢ^{B}.

The ratio of the count of the node number i ∈ I_{A} for the business entity B to the count of the corresponding node for the business entity A is as follows.

$${q}_{i}^{B \vert A} = \{ \begin{matrix}\frac{{S}_{i}^{B}}{{S}_{i}^{A}} ( {S}_{i}^{B} < {S}_{i}^{A} ) \\ 1.0 ( {S}_{i}^{B} \geq {S}_{i}^{A} )\end{matrix}$$

The degree of similarity of the business entity B to the business entity A is denoted as τ_{B|A}. The degree of similarity is calculated as follows by determining an average of the ratios for the individual nodes.

$${T}_{B \vert A} = \frac{1}{{n}_{A}} {\sum }_{i ∈ {I}_{A}} {q}_{i}^{B \vert A}$$

The degree-of-trust calculation unit 114 may calculate the degree of trust reliability based on the root mean square using a general formula described below.

It is assumed that the business entity being evaluated is the business entity A, and that the business entity A has a business relationship with N business entities and are linked to the N business entities. The degree of similarity of the business entity Cⱼ to the business entity A is denoted as τ_{Cj|A}. The degree of trust reliability T_{A} for the business entity A is determined as follows.

$${T}_{A} = \sqrt{\frac{1}{N} {\sum }_{j = 1} {( {τ}_{Cj \vert A} )}^{2}}$$

The degree-of-trust calculation unit 114 may calculate the degree of trust reliability based on the subjective logic using a general formula described below.

Trust is expressed using three parameters of b (belief), d (disbelief), and u (uncertainty). These three parameters satisfy a condition of b+d+u=1.

In the subjective logic, the trust of the counterparty is expressed in a beta distribution. In the beta distribution, p is a value indicating a probability in a range from 0 to 1 and positive real numbers α and β are given. A probability density function Beta(p, α, β) of p and an expectation value Eₚ thereof may be expressed as follows. Note that Γ(x) represents a gamma function.

$$Beta ( p , α , β ) = \frac{Γ ( α + β )}{Γ ( α ) Γ ( β )} {{p}^{α - 1} ( 1 - p )}^{β - 1}$$

$${E}_{p} = α / ( α + β )$$

In the subjective logic, p in the beta distribution is considered as the ratio of positive opinions on the counterparty (for example, the ratio of trusting the counterparty). Thus, α and β are set as follows.

$$\{ \begin{matrix}α = \frac{2 b}{u} + 1 \\ β = \frac{2 d}{u} + 1\end{matrix}$$

Thus, the expectation value of the trust p in the subjective logic is denoted as Eₚ=(2b+u)/2.

Suppose that there are two sets of trust information for an evaluation target X. Let

b_{X}¹,b_{X}²

denote belief, and let

u_{X}¹,u_{X}²

denote uncertainty.

In a fusion operation called averaging fusion in the subjective let

$${b}_{X}^{1 \underline{◇} 2} , {u}_{X}^{1 \underline{◇} 2}$$

(where ⋄ denotes an operator of the fusion operation) denote the fusion values of belief and uncertainty. Then, the fusion values are calculated as follows.

$$\{ \begin{matrix}{b}_{X}^{1 \underline{◇} 2} = \frac{{b}_{X}^{1} {u}_{X}^{2} + {b}_{X}^{2} {u}_{X}^{1}}{{u}_{X}^{1} + {u}_{X}^{2}} \\ {u}_{X}^{1 \underline{◇} 2} = \frac{2 {u}_{X}^{1} {u}_{X}^{2}}{{u}_{X}^{1} + {u}_{X}^{2}}\end{matrix}$$

The fact that there is a business relationship between business entities and the business entities have already been linked to each other is regarded that disbelief is 0 (d=0). It is assumed that the degree of similarity between the competencies of the business entities is equal to belief. Thus, uncertainty is calculated as u=1−τ according to the condition on the parameters in the subjective logic.

It is assumed that the business entity being evaluated is the business entity A. The degree of similarity of the business entity B to the business entity A is denoted as τ_{B|A}, and the degree of similarity of the business entity C to the business entity A is denoted as τ_{C|A}.

From the conditions above, the fusion values of the trust in the business entity A from the business entity B and the trust in the business entity A from the business entity C are as follows.

$$\{ \begin{matrix}{b}_{A}^{B \underline{◇} C} = \frac{{τ}_{B \vert A} + {τ}_{C \vert A} - 2 {τ}_{B \vert A} {τ}_{C \vert A}}{2 - {τ}_{B \vert A} - {τ}_{C \vert A}} \\ {u}_{A}^{B \underline{◇} C} = 1 - {b}_{A}^{B \underline{◇} C}\end{matrix}$$

Next, the degree of similarity of the business entity D to the business entity A is denoted as τ_{D|A}. Then, the fusion values obtained by further fusing the trust from the business entity D with the trust from the business entities B and C are as follows.

$$\{ \begin{matrix}{b}_{A}^{B \underline{◇} C \underline{◇} D} = \frac{{b}_{A}^{B \underline{◇} C} + {τ}_{D \vert A} - 2 {b}_{A}^{B \underline{◇} C} {τ}_{D \vert A}}{2 - {b}_{A}^{B \underline{◇} C} - {τ}_{D \vert A}} \\ {u}_{A}^{B \underline{◇} C \underline{◇} D} = 1 - {b}_{A}^{B \underline{◇} C \underline{◇} D}\end{matrix}$$

Likewise, fusion is performed for business entities E, F, and so on. Consequently, the fusion values obtained for all the linked business entities are calculated as follows.

$$\{ \begin{matrix}{b}_{A}^{\underline{◇} *} = {b}_{A}^{B \underline{◇} C \underline{◇} D \underline{◇} E \underline{◇} F} \\ {u}_{A}^{\underline{◇} *} = 1 - {b}_{A}^{\underline{◇} *}\end{matrix}$$

Then, the expectation value of the beta distribution determined from the parameter of the trust resulting from fusion is calculated as follows, where T_{A} denotes the degree of trust reliability for the business entity A being evaluated.

$${T}_{A} = \frac{{b}_{A}^{\underline{◇} *} + 1}{2}$$

[A-2] Example of Operation

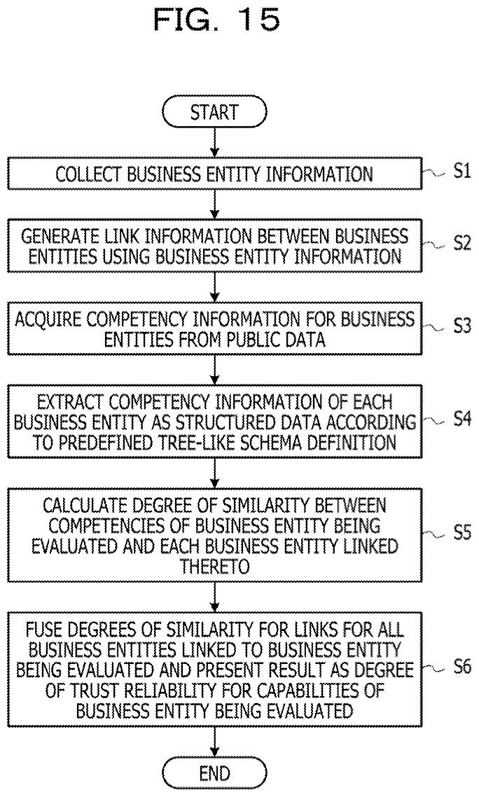

The process of calculating the degree of trust reliability performed in the information processing apparatus 1 illustrated in FIG. 1 will be described in accordance with a flowchart (steps S1 to S6) illustrated in FIG. 15.

The graph generation unit 111 collects the business entity information 141 (step S1).

The graph generation unit 111 generates the link information between business entities using the business entity information 141 (step S2).

The competency generation unit 112 acquires the competency information of the business entities from the public data 142 (step S3).

The competency generation unit 112 extracts the competency information of each business entity as structured data according to a predefined tree-like schema definition (step S4).

The degree-of-similarity calculation unit 113 calculates the degree of similarity between the competency of the business entity being evaluated and the competency of each business entity linked to the business entity being evaluated (step S5).

The degree-of-trust calculation unit 114 fuses the degrees of similarity for the links for all the business entities linked to the business entity being evaluated, and presents the result as the degree of trust reliability for the capabilities of the business entity being evaluated (step S6). Then, the process of calculating the degree of trust reliability ends.

[A-3] Effects

The degree-of-similarity calculation unit 113 calculates a degree of similarity between the business entity being evaluated and a counterparty business entity having a business relationship with the business entity being evaluated. The degree-of-trust calculation unit 114 generates information on the degree of trust in the business entity being evaluated, based on the calculated degree of similarity.

Consequently, the accuracy of information on the degree of trust in a counterparty may be improved. The degree of similarity in competency is calculated to generate the information on the degree of trust. The higher the similarity between parties, the better the position of the counterparty is understood. Thus, the effect of trusting the counterparty (salient value similarity; M. Siegrist, G. Cvetkovich, C. Roth, “Salient Value Similarity, Social Trust, and Risk/Benefit Perception”, Risk Analysis, 2000) is usable. For example, how much the link is usable as reliable trust information may be indicated by the degree of similarity in competency.

The degree-of-similarity calculation unit 113 calculates the degree of similarity, based on classification of intellectual property owned by the business entity being evaluated and the counterparty business entity.

Consequently, the degree of similarity between the business entities may be calculated using public data.

The degree-of-trust calculation unit 114 generates the information on the degree of trust, based on a root mean square of the degrees of similarity between the business entity being evaluated and the individual counterparty business entities.

Consequently, the information on the degree of trust may be easily generated.

The degree-of-trust calculation unit 114 generates the information on the degree of trust by fusing the degrees of trust the individual counterparty business entities have in the business entity being evaluated.

In the case where the degree of similarity is low and the capabilities of the business entity being evaluated are not well known (uncertain), the subjective logic has a property that the degree of trusting the counterparty (belief) does not increase even if a fusion operation is performed. Due to this property, even if there are many business entities linked to the business entity being evaluated, the degree of trust reliability for the business entity being evaluated does not increase if each value of the degrees of similarity is small. Therefore, instead of the number of links to the business entity being evaluated, links with the high degrees of similarity to the capabilities of the business entity being evaluated may be used as reliable information for trust in the business entity being evaluated.

[B] Others

The technique disclosed herein is not limited to the above-described embodiment and may be variously modified and carried out without departing from the gist of the present embodiment. The configurations and processes according to the present embodiment may be selectively adopted or omitted as desired or may be combined appropriately.

In the example of the above-described embodiment, the classification of intellectual property such as patents is used to calculate the degree of similarity. However, the present embodiment is not limited to this example. For example, classification of one or more business types in which business entities perform business activities may be defined in a tree structure, and the degree of similarity may be calculated based on the classification of the business types.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A generation method implemented by a computer, the method comprising:
calculating a degree of similarity between a business entity being evaluated and a counterparty business entity that has a business relationship with the business entity being evaluated; and
generating information on a degree of trust in the business entity being evaluated, based on the calculated degree of similarity.

2. The generation method according to claim 1, wherein
the degree of similarity is calculated based on classification of intellectual property owned by the business entity being evaluated and the counterparty business entity.

3. The generation method according to claim 1, wherein
the information on the degree of trust is generated based on a root mean square of the degrees of similarity between the business entity being evaluated and the individual counterparty business entities.

4. The generation method according to claim 1, wherein
when there are individual counterparty business entities in the business entity, the information on the degree of trust is generated through fusion of degrees of trust the individual counterparty business entities have in the business entity being evaluated.

5. An information processing apparatus comprising:
a memory; and
a processor coupled to the memory, the processor being configured to:
calculate a degree of similarity between a business entity being evaluated and a counterparty business entity that has a business relationship with the business entity being evaluated; and
generate information on a degree of trust in the business entity being evaluated, based on the calculated degree of similarity.

6. A non-transitory computer-readable storage medium for storing a generation program which causes a processor to perform processing, the processing comprising:
calculating a degree of similarity between a business entity being evaluated and a counterparty business entity that has a business relationship with the business entity being evaluated; and
generating information on a degree of trust in the business entity being evaluated, based on the calculated degree of similarity.
